(19) United States
(12) Patent Application Publication
(10) Pub. No.: US 2023/0053400 A1
(43) Pub. Date: Feb. 23, 2023

(54) BEVERAGE HEATING SYSTEM

(71) Applicant: Cameron Kent, Benowa (AU)

(72) Inventor: Cameron Kent, Benowa (AU)

(21) Appl. No.: 17/796,201

(22) PCT Filed: Jan. 29, 2021
(86) PCT No.: PCT/AU2021/050058

§ 371 Date: Jul. 28, 2022

(30) Foreign Application Priority Data
Jan. 29, 2020 (AU) 2020900231

(51) Int. Cl. A47J 36/28; A47G 19/22; A47J 36/24; F24V 30/00

(52) U.S. Cl. CPC A47J 36/28; A47G 19/2288; A47J 36/2444; F24V 30/00; A47G 23/0313

(57) ABSTRACT

A beverage heating system is provided that enables hot beverages, such as coffee or tea, to be enjoyed at a desired temperature for a longer period of time, without requiring the beverages to be reheated, and without requiring any external power source. The system comprises a hot beverage reservoir, for receiving a hot beverage for consumption therefrom; and a self-heating element, configured to heat a base portion of the hot beverage reservoir, during consumption therefrom, to maintain a desired temperature of the hot beverage, without requiring any external power. The self-heating element may be configured to heat based upon an exothermic reaction.

### TECHNICAL FIELD

The present invention relates to hot beverages, and in particular, although not exclusively, to heating beverages such as tea, coffee and hot chocolate.

### BACKGROUND ART

Paper-based, single-use coffee cups are widely used though out the world as a convenient way of providing heated beverages, such as tea, coffee, hot chocolate and the like. As these cups are single use, they are particularly useful for take-away beverages, but also alleviate the need to wash and maintain multi-use cups.

A problem with such single-use coffee cups is that the hot beverages therein quickly lose their heat, which is clearly undesirable. It is well established that the heat is maintained for a longer period if a lid is used, however, many consumers prefer to drink their coffee without a lid. As such, these consumers are unable to enjoy their beverage over any significant period of time, without it cooling, and becoming lukewarm.

Furthermore, even when a lid is used, beverages will typically only stay at an appropriate temperature for approximately 5-10 minutes. If purchasing take-away coffee, this can mean that by the time the coffee is at its desired destination (e.g. home or at an office), it is already below its desired temperature, let alone during consumption.

The problem is even greater in cold climates, as is common in winter in many northern hemisphere countries, as cold weather can accelerate the cooling of beverages, e.g. when being transported outdoors.

Insulated coffee cups and flasks exist, which are configured to maintain a temperature of the coffee (or hot beverage) therein. Such cups and flasks are, however, expensive, and thus not suitable for single use. Furthermore, such cups and flasks require the beverage to be sealed from the atmosphere to maintain a temperature of the coffee for any significant period. As such, these cups and flasks are not suitable as a general replacement for traditional coffee cups.

As such, there is clearly a need for an improved beverage heating system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a beverage heating system which may at least partially overcome at least one of the abovementioned disadvantages or provide the consumer with a useful or commercial choice.

With the foregoing in view, in a first aspect the present invention resides broadly in a beverage heating system comprising:

a hot beverage reservoir, for receiving a hot beverage for consumption therefrom; and

a self-heating element, configured to heat the hot beverage reservoir, during consumption therefrom, to maintain a desired temperature of the hot beverage, without requiring any external power.

Advantageously, the beverage heating system enables hot beverages, such as coffee or tea, to be enjoyed at a desired temperature for a longer period of time, without requiring the beverages to be reheated, and without requiring any external power source.

Preferably, the self-heating element is configured to heat a base portion of the hot beverage reservoir.

Preferably, the hot beverage reservoir comprises a cup. Preferably, the self-heating element comprises a pod attached to the cup.

Preferably, the cup is a single-use cup. The single-use cup may be formed at least in part of paper. The paper may be sealed, e.g. using a bioplastic. Alternatively, the cup may comprise a reusable cup.

The cup may define a recess for snugly accommodating the self-heating element. The recess may be defined in a base of the cup.

The cup may define a heating area, at a base of the cup, for receiving the self-heating element. The hot beverage reservoir may include a substantially planar base, wherein the heating area is defined at least in part by the substantially planar base.

The substantially planar base may be configured to conduct heat more efficiently than sidewalls of the cup. As an illustrative example, the sidewalls may be formed of plastic or plastic like material, and the base may be formed of metal.

The cup may be circular in cross section. The self-heating element may be circular in cross section.

The self-heating element may be substantially cylindrical in shape. The self-heating element may include slightly tapered sidewalls, and thus be slightly frustoconical in shape.

The self-heating element may be single use. The self-heating element may be reusable.

The self-heating element may be configured to heat based upon an exothermic reaction. The exothermic reaction may comprise a reaction with one or more components of the self-heating element and air. The self-heating element may include one or more removable tabs to expose the one or more components to air.

The self-heating element may include powdered iron, configured to react with oxygen from the air to generate heat. The heating element may include salt to catalyse the reaction.

The self-heating element may be configured to heat based upon a change in state of one or more materials. The change in state may comprise crystallisation.

The self-heating element may include a supersaturated solution. The supersaturated solution may comprise sodium acetate. The supersaturated solution may be activated by generation nucleation centres to initiate crystallisation.

The self-heating element may be adapted to be attached to the cup. The self-heating element may include an adhesive on a surface thereof, to adhere the self-heating element to the cup.

The self-heating element may be formed with the cup. A floor of the hot beverage reservoir may comprise a ceiling of the self-heating element.

The self-heating element may be concealed by the cup. The self-heating element may be concealed by sidewalls of the cup.

The cup may include a tray, for receiving the self-heating element. The tray may slidably engage with the cup, to enable access thereto. The tray may be open from above.

In another form, the invention resides broadly in a self-heating element adapted to heat a base portion of a hot beverage reservoir, for receiving a hot beverage for consumption therefrom, to maintain a desired temperature of the hot beverage, during consumption therefrom, without requiring any external power.

In yet another form, the invention resides broadly in a reusable hot beverage reservoir, for receiving a hot beverage for consumption therefrom, the hot beverage reservoir defining a heating area at a base thereof, for receiving a self-heating element, the hot beverage reservoir including a substantially planar base, wherein the heating area is defined at least in part by the substantially planar base, such that when the self-heating element is installed into the heating area, heat is transferred to the hot beverage reservoir by the substantially planar base.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a top view of a self-heating element in the form of a pod for heating a hot beverage reservoir, according to an embodiment of the present invention.

FIG. 2 illustrates a bottom view of the pod of FIG. 1.

FIG. 3 illustrates a side view of the pod of FIG. 1.

FIG. 4 illustrates a bottom view of the pod of FIG. 1, with the tab removed.

FIG. 5a illustrates a side view of a single use cup, to which the pod of FIG. 1 may be attached.

FIG. 5b illustrates a cross sectional view of the cup of FIG. 5a.

FIG. 5c illustrates a cross sectional view of the cup of FIG. 5a with the pod installed.

FIG. 6 illustrates a press forming die, for pressing portions of pods, similar to the pods of FIG. 1, according to an embodiment of the present invention.

FIG. 7 illustrates a side view of a pod, manufactured according to the process described with reference to FIG. 6, according to an embodiment of the present invention.

FIG. 8 illustrates an enlarged view of detail A of FIG. 7.

FIG. 9 illustrates a side cross sectional view of a cup according to an embodiment of the present invention.

FIG. 10 illustrates an enlarged view of detail B of FIG. 9.

FIG. 11 illustrates a side view of a reusable cup, according to an embodiment of the present invention.

FIG. 12 illustrates a cross-sectional view of the cup of FIG. 11.

FIG. 13 illustrates a rear view of a reusable cup, according to an embodiment of the present invention.

FIG. 14 illustrates a side view of the cup of FIG. 13.

FIG. 15 includes a side cross-sectional view of the cup of FIG. 13.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

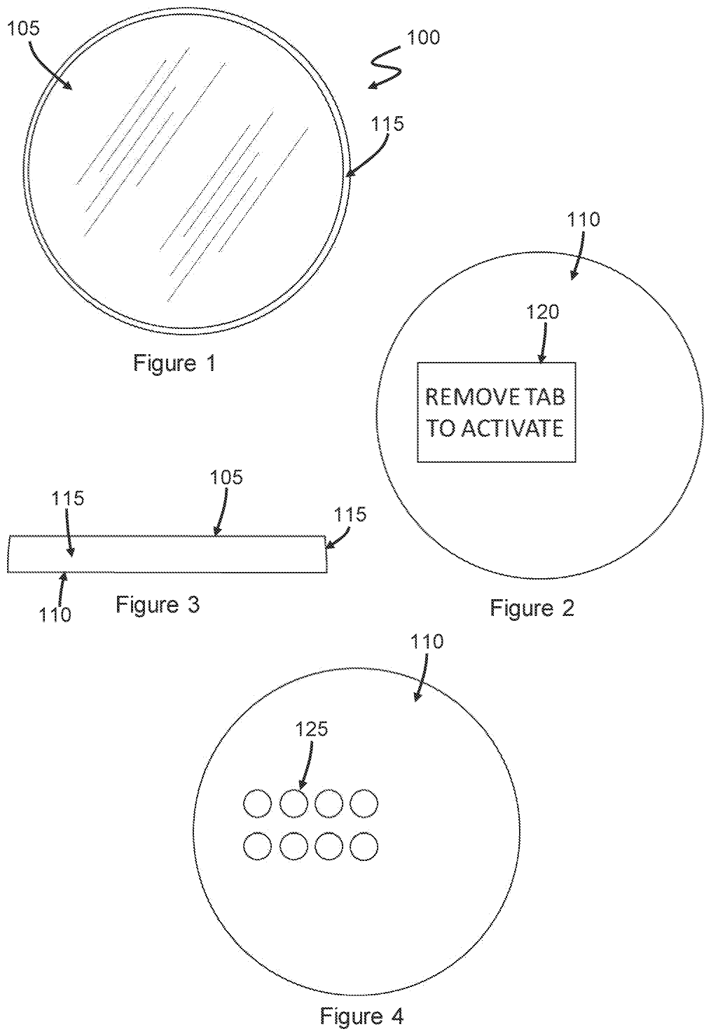

FIG. 1 illustrates a top view of a self-heating element in the form of a pod 100 for heating a hot beverage reservoir in the form of a single-use (disposable) cup, according to an embodiment of the present invention. FIG. 2 illustrates a bottom view of the pod 100, and FIG. 3 illustrates a side view of the pod.

Advantageously, the pod 100 enables hot drinks, such as coffee, tea or hot chocolate, in the disposable cup to stay at a desirable temperature (i.e. hot) longer. As such, consumers are able to enjoy their hot drinks over a longer period of time, without requiring the beverages to be reheated, and without requiring any external power source.

The pod comprises a substantially planar upper surface 105, a substantially planar lower surface 110, parallel to the substantially planar upper surface 105, and a sidewall 115 extending between the upper and lower surfaces 105, 110.

The upper and lower surfaces 105, 110 are substantially circular in shape, and the sidewall 115 extends around a circumference of the upper and lower surfaces 105, 110 and therebetween to define a substantially cylindrical shape.

The upper surface 105 includes an adhesive on a surface thereof, to adhere the pod 100 to the cup. In particular, and as outlined in further detail below, the pod 100 attaches to a base of the cup, and is thereby configured to heat the contents of the cup (i.e. the beverage), to maintain a heat of the beverage.

The pod 100 is substantially cylindrical in shape, and includes slightly tapered sidewalls, as best illustrated in FIG. 3, and is thus slightly frustoconical in shape. Such configuration simplifies the installation of the pod 100 to the cup, as the innermost surface of the pod 100 (i.e. the upper surface 105) is smaller than the outermost surface of the pod 100 (i.e. the lower surface 110).

The pod 100 is sealed, and is configured to heat based upon an exothermic reaction with one or components of the pod 100 and air. In particular, the pod 100 includes a removable tab 120 to expose the one or more components to air.

FIG. 4 illustrates a bottom view of the pod 100, with the tab 120 removed, exposing a plurality of apertures 125, which thereby allow air to reach the components of the pod 100 to thereby initiate the exothermic reaction.

The pod 100 includes powdered iron, which is configured to react with oxygen from the air to for iron oxide and generate heat. The pod includes salt to catalyse the reaction, and activated charcoal to hold the water necessary for the oxidizing reaction to occur, carbon, and/or vermiculite.

The pod 100 includes a microporous pouch (not illustrated), retaining the powdered iron, while letting oxygen travel therethrough to enable the reaction. The pouch thus enables the apertures 125 to be relatively large, without risking the powdered iron falling therethrough.

The pouch may be formed of cloth-like material, and the skilled addressee will readily appreciate that such cloth-like material may be used in other embodiments without a pouch, such as simply above the tabs, or partially surrounding the powdered iron.

Due to characteristics of the reaction, the pod 100 is single use. The skilled address will, however, readily appreciate that any suitable exothermic reaction may be used in place of the above. Similarly, pods 100 may be made to generate heat based upon a change in state of one or more materials therein, such as, by crystallisation.

As an illustrative example, the pod may include a supersaturated solution of sodium acetate, which may be activated by generation of nucleation centres to initiate crystallisation (e.g. by flexing a small medal disk in the solution). In such case, the pod may be reusable by dissolving the crystals through heating, to again create a supersaturated solution.

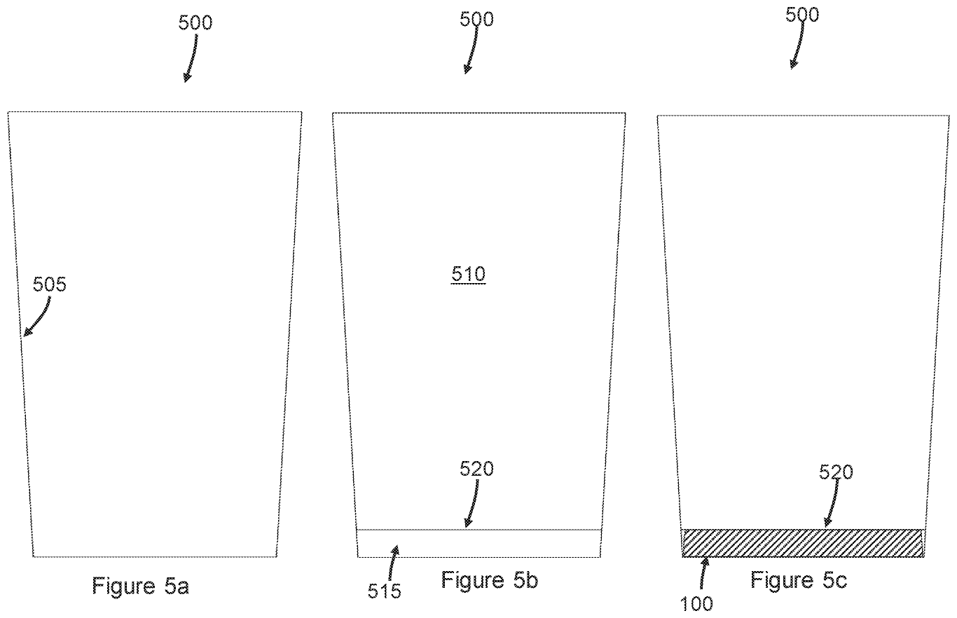

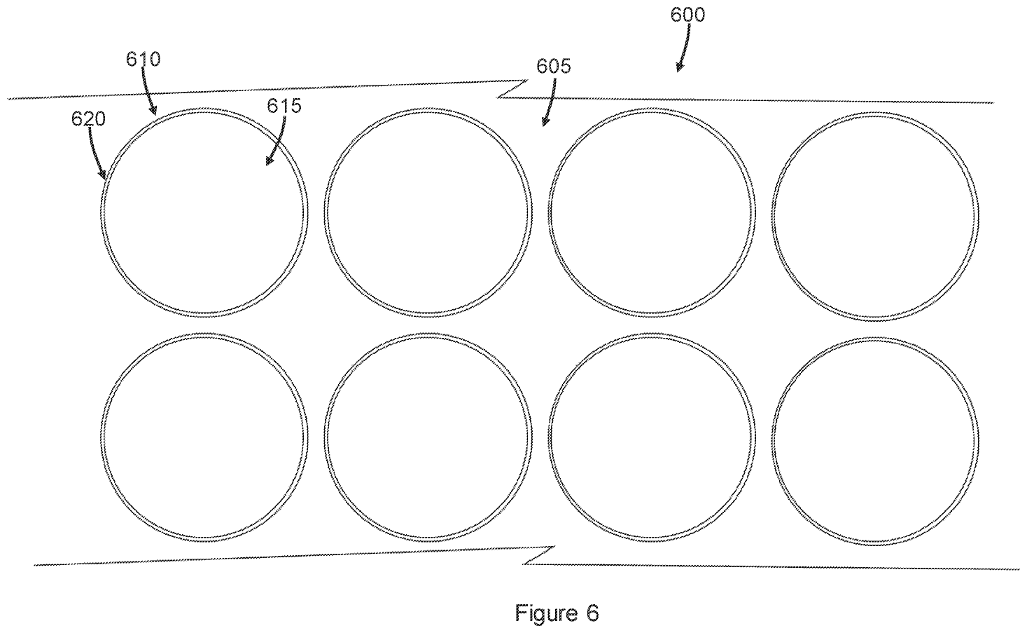

FIG. 5a illustrates a side view of a single use cup 500, to which the pod 100 may be attached. The single use cup is formed of paper, which is sealed using a bioplastic. The skilled addressee will, however, readily appreciate that the cup 500 may be formed of any suitable material.

As the pod 100 includes adhesive, it is easy to attach, and may be selectively attached to a cup in a café or similar if desired by the consumer, as outlined in further detail below.

FIG. 5b illustrates a cross sectional view of the cup 500. The cup includes sidewalls 505, which define a frustoconical hot beverage reservoir 510, for receiving a hot beverage, such as tea, coffee or hot chocolate, as is known in the prior art.

The cup defines a heating area 515, ata base of the cup 500, for receiving the pod 100. The hot beverage reservoir 510 includes a substantially planar base 520, the heating area defined in part by the substantially planar base 520. In particular, a floor of the hot beverage reservoir 510 comprises a ceiling of the heating area 515.

The heating area 515 defines a recess, open from a bottom of the cup 500, for snugly receiving and accommodating the pod 100. In particular, the pod 100 is inserted into the heating area 515, and adhered to a bottom of the substantially planar base 520 using the adhesive.

FIG. 5c illustrates a cross sectional view of the cup 500 with the pod 100 installed. As can be seen, the pod 100 fill substantially an entire portion of the heating area 515, and does not protrude outwardly therefrom. As such, the sidewalls 505 conceal the heating pod.

In use, the hot beverage may be consumed from the cup 500 in the same manner as a traditional cup, but over a longer period of time (without the beverage going cold). As the pod 100 is concealed in the base of the cup 500, the consumer need not necessarily know that the pod 100 is even there.

The pods 100 are advantageously mass produced separately to the cups 500, to enable the pods to be selectively attached to cups as desired.

FIG. 6 illustrates a press forming die 600, for pressing portions of pods, similar to the pods, according to an embodiment of the present invention.

The die includes a base 605, from which a plurality of die form elements 610 upwardly extend. Each die form element 610 comprises a planar top 615, spaced from and parallel to the base 605, and a circumferentially extending sidewall 620 extending upwardly from the base 605 to the top 615. The sidewalls 620 are slightly tapered, and thus are slightly frustoconical in shape.

While the die is illustrated with rows of four die form elements 610, the skilled addressee will readily appreciate that any suitable number of die form elements 610 may be used in any suitable arrangement.

The die 600 is used to press paper (card) into small cups. Each cup comprises a substantially planar base, from which sidewalls upwardly extend.

The cups are inverted, such that they are open from above, and filled with chemical heating material, such as the iron mixture described, in an environment sealed from the atmosphere (to avoid creating an initial reaction), which are sealed with a planar lid to form the pod. The planar lid may include the tab, as outlined above, and the chemical heating material may be provided in a microporous pouch, to prevent spilling.

The pod is then inverted again for use, such that the cup portion forms an upper edge of the pod.

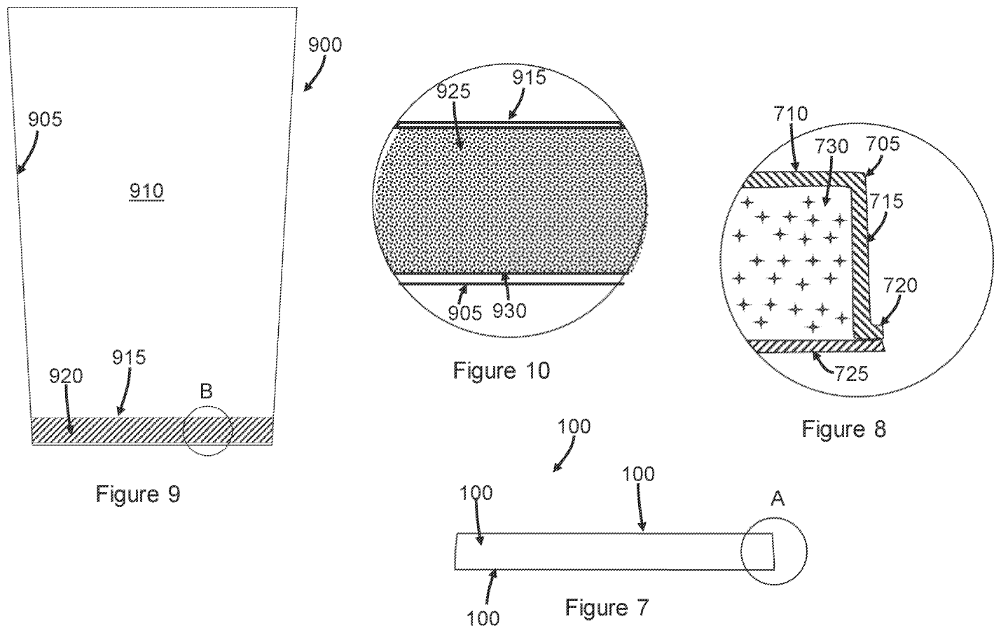

FIG. 7 illustrates a side view of a pod 700, manufactured according to the process described with reference to FIG. 6, according to an embodiment of the present invention. FIG. 8 illustrates an enlarged view of detail A of FIG. 7.

The pod 700 comprises an inverted cup portion 705 including a planar base 710, that is circular in shape, from which a peripheral sidewall 715 extends. The sidewall 715 include a distal flange 720, which extends outwardly from the sidewall 715, which functions to provide a surface to which a lid 725 may attach.

The cup portion 705 is tightly filled with chemical heating material 730, and the lid 725 is installed to retain the heating material 730 therein. In particular, the lid 725 is adhered to the flange 720 using a suitable adhesive.

While the above describes pods that are manufactured for installation separately to the cups, the skilled addressee will readily appreciate that the cup may be manufactured to include a self-heating element (similar to the pods) therein.

FIG. 9 illustrates a side cross sectional view of a cup 900 according to an embodiment of the present invention. FIG. 10 illustrates an enlarged view of detail B of FIG. 9.

The cup 900 comprises sidewalls which define a frustoconical hot beverage reservoir 910, for receiving a hot beverage, such as tea, coffee or hot chocolate. The reservoir is defined by a planar base 915 at a lower end of the cup 900. A self-heating element 920, similar to the pods described above, is defined directly below the base 915.

As best illustrated in FIG. 10, the planar base 915 of the reservoir 910 defines a ceiling of the self-heating element 920. In particular, chemical heating material 925, such as an iron mixture, is provided in a space defined between the planar base 915 of the reservoir 910 and a base 930 of the self-heating element 920.

Furthermore, and again as best illustrated in FIG. 10, the sidewalls extend down past the bottom of the pod, and as such, there is a space defined under the pod.

The cup may be manufactured by first generating a cup portion, inverting the cup portion, filling the self-heating element 920 with chemicals, and sealing the self-heating element 920 with the base 930.

As will be readily appreciated by the skilled addressee, the base 930 may include an activation tab, as outlined above in relation to the other embodiments.

Finally, the sidewalls 905 may extend down past the base 930 to ensure that the cup is supported by the sidewalls 905 rather than the self-heating element 920. This also ensures that air is able to react with the iron mixture therein.

In some embodiments, the sidewalls 905 may include notches or apertures, to ensure that air is able to flow to the self-heating element 920 even when placed on a planar surface, such as a table. The notches may extend upwardly from a bottom of the sidewalls around a periphery of the base of the cup.

In the embodiments described above, the apertures for activating the self-heating elements or pods are located at a base of the pod. However, in other embodiments, the apertures may be provided directly in the sidewalls of the cup, or any other suitable location. In one particular embodiment, apertures may be provided around a periphery of the sidewalls at the base, and exposed by removing a tab or strip such that the self-heating elements are activated from the sides.

While the above embodiments describe single use (disposable) cups, the skilled addressee will readily appreciate that the invention may utilise reusable cups or similar drinking vessels.

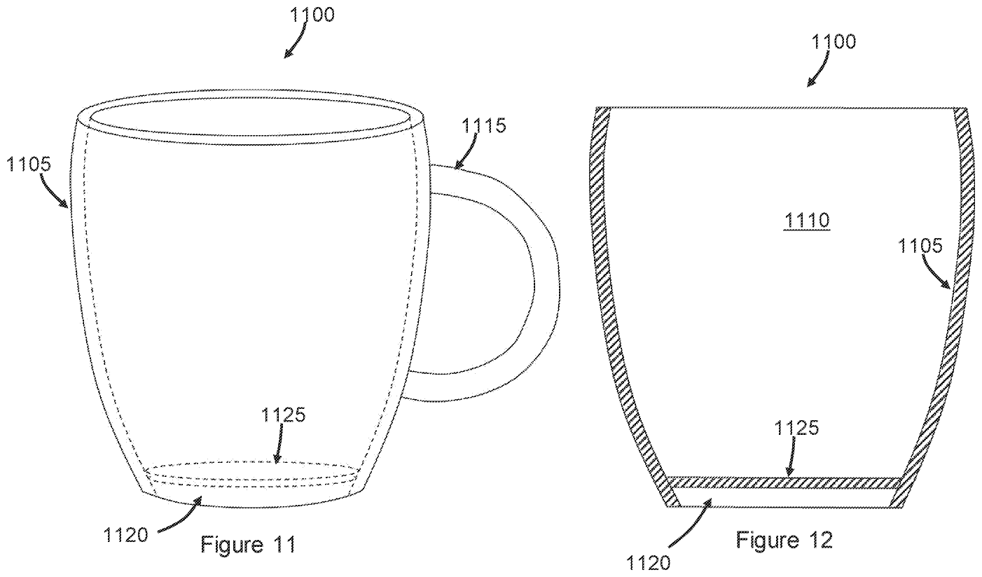

FIG. 11 illustrates a side view of a reusable cup 1100, according to an embodiment of the present invention. FIG. 12 illustrates a cross-sectional view of the cup 1100.

The cup 1100 comprises sidewalls 1105 defining a hot beverage reservoir 1110, for receiving the hot beverage. A handle 1115 extends outwardly from the sidewalls 1105 to provide a convenient means for holding the cup 1100.

The cup 1100 defines a heating area 1120, ata base of the cup, for receiving a self-heating element such as a pod, like the pod 100. The hot beverage reservoir 1110 includes a substantially planar base 1125, and the heating area 1120 is defined (in part) by the substantially planar base 1125.

When the self-heating element is installed into the heating area 1120, heat is transferred to the hot beverage reservoir 1110 by the substantially planar base 1125.

The self-heating element may be adhered (i.e. stuck) to the heating area 1120, e.g. using a tape-like adhesive. Alternatively, the self-heating element may be held in the heating area 1120 by a press-fit arrangement.

The sidewalls and handle may be formed of impact resistant material, such as polypropylene or another suitable material. The substantially planar base 1125 may be configured to conduct heat more efficiently than sidewalls of the cup. As an illustrative example, the base 1125 may be formed of metal to assist in the transfer of heat from the heating area 1120 to the hot beverage reservoir 1110.

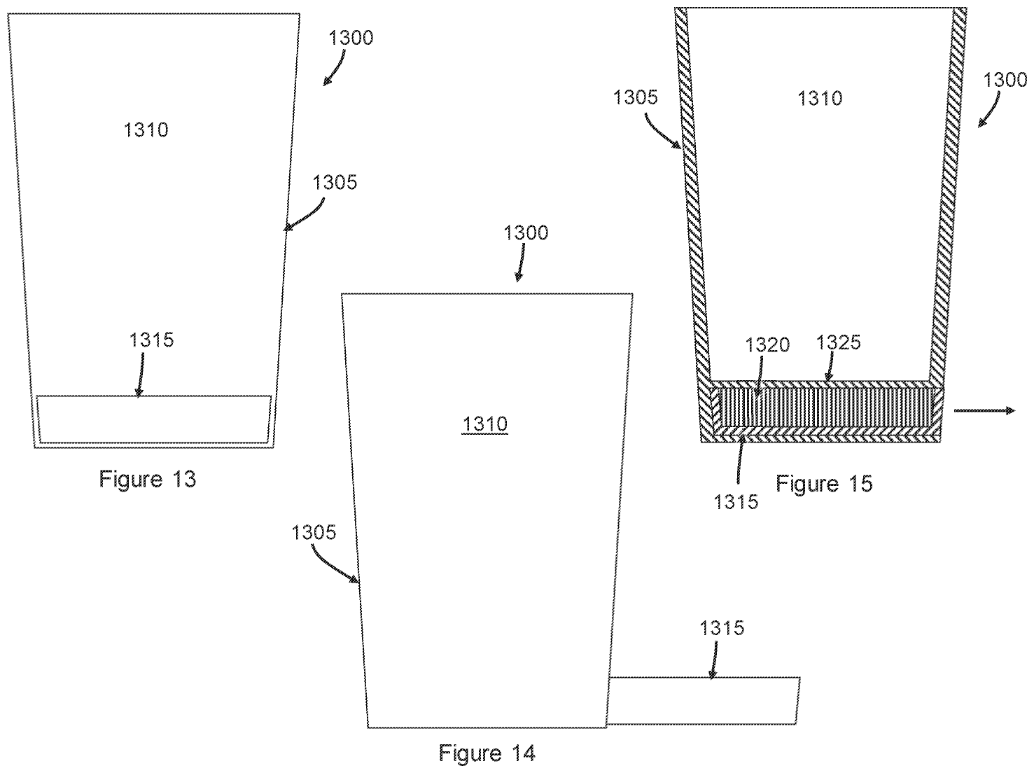

FIG. 13 illustrates a rear view of a reusable cup 1300, according to an embodiment of the present invention. FIG. 14 illustrates a side view of the cup 1300, and FIG. 15 includes a side cross-sectional view of the cup 1300.

The cup 1300 is similar to the cup 1100, and includes sidewalls 1305 defining a hot beverage reservoir 1310, for receiving a hot beverage.

The cup 1300 includes a heating tray 1315, ata base of the cup 1300, for receiving a self-heating element 1320, which may be similar to the pod 100. The heating tray 1315 may be opened and closed to receive the self-heating element. The heating tray 1315 is closed in FIGS. 13 and 15, and open in FIG. 14.

The heating tray 1315 is slidably engaged with the base of the cup 1300, such that the tray 1315 may be slid out, to provide access thereto, much like a drawer. The tray 1315 itself includes a base and sidewalls extending upwardly therefrom, defining a reservoir for receiving the self-heating element. The sidewalls of the tray 1315 may engage with corresponding portions of the base of the cup 1300, e.g. using guides.

The tray 1315 is open from above, enabling heat therefrom to directly heat a substantially planar base 1325 of the reservoir 1310.

In use, the self-heating element 1320 may be opened (starting the reaction), and simply be positioned in the tray 1315, without any adhesive. As such, the self-heating element 1320 may be simply removed and replaced, as needed.

The cup 1300 may be formed of impact resistant material, such as polypropylene or another suitable material. The substantially planar base 1325 may be configured to conduct heat more efficiently than sidewalls of the cup. As an illustrative example, the substantially planar base 1325 may be formed of metal to assist in the transfer of heat from the tray 1315 to the hot beverage reservoir 1310.

In other embodiments, the tray 1315 may pivot out from the cup around a vertical axis. Any suitable locking mechanism may be used to prevent the tray 1315 from inadvertently opening during use of the cup 1300.

The cups described above are circular in cross section, however the skilled addressee will readily appreciate that the cups may take any suitable shape. However, for disposable cups, the circular cross section is believed to provide a good balance between complexity, cost and strength.

In other embodiments, the hot beverage reservoir may comprise a double-walled reservoir, similar to an insulated mug, flask or container. In such case, the pods may be replaced by heating sheets which are configured to be received between inner and outer walls of the double-walled reservoir. As such, the double-walled reservoir may function simply as an insulator (without the heating sheet), or be used to actively provide heat to the beverage (with the heating sheet).

The pods described above may be manufactured according to a wide range of desired characteristics. In one embodiment, the pods may be adapted to heat to about 55 degrees Celsius for about 30 minutes. In other embodiment, the pods may be adapted to heat to about 80 degrees Celsius. In yet another embodiment, the pod may be adapted to heat to between about 50 and 90 degrees Celsius. Preferably, the pod heats within a short timeframe (e.g. 2-3 minutes at most) so that the pod is able to function before the beverage has had a chance to cool significantly.

Preferably, the pod is arranged so that it either does not reach a temperature where it can cause burns, or is sufficiently shielded so that such heat is unable to come in contact with a consumers skin. In one embodiment, a heat reflective or insulating material is provided to insulate the pod, and thus ensure that heat from the pod is directed primarily to the beverage. As an illustrative example, aluminium foil may be provided on an underside of the pod.

While the term “chemical” is used above, the skilled addressee will readily appreciate that the ingredients used may be natural occurring chemicals or ingredients, and may be non-toxic.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A beverage heating system comprising:
a hot beverage reservoir, for receiving a hot beverage for consumption therefrom; and
a self-heating element, configured to heat the hot beverage reservoir, during consumption therefrom, to maintain a desired temperature of the hot beverage, without requiring any external power.

2. The beverage heating system of claim 1, wherein the hot beverage reservoir comprises a cup.

3. The beverage heating system of claim 2, wherein the cup is a single-use cup.

4. The beverage heating system of claim 2, wherein the cup is a reusable cup.

5. The beverage heating system of claim 2, wherein the cup defines a recess for snugly accommodating the self-heating element.

6. The beverage heating system of claim 5, wherein the recess is defined in a base of the cup.

7. The beverage heating system of claim 2, wherein the cup defines a heating area, at a base of the cup, for receiving the self-heating element, wherein the hot beverage reservoir includes a substantially planar base, and wherein the heating area is defined at least in part by the substantially planar base.

8. The beverage heating system of claim 7, wherein the substantially planar base conducts heat more efficiently than sidewalls of the cup.

9. The beverage heating system of claim 1, wherein the self-heating element is substantially cylindrical in shape.

10. The beverage heating system of claim 1, wherein the self-heating element is single use.

11. The beverage heating system of claim 1, wherein the self-heating element is configured to heat based upon an exothermic reaction.

12. The beverage heating system of claim 11, wherein the exothermic reaction comprises a reaction with one or more components of the self-heating element and air, and wherein the self-heating element includes one or more removable tabs to expose the one or more components to air.

13. The beverage heating system of claim 12, wherein the self-heating element includes powdered iron, configured to react with oxygen from the air to generate heat.

14. The beverage heating system of claim 1, wherein the self-heating element is configured to heat based upon a change in state of one or more materials.

15. The beverage heating system of claim 1, wherein the self-heating element includes a supersaturated solution.

16. The beverage heating system of claim 2, wherein the self-heating element includes an adhesive on a surface thereof, to adhere the self-heating element to the cup.

17. The beverage heating system of claim 2, wherein the self-heating element is formed with the cup.

18. The beverage heating system of claim 2, wherein the self-heating element is concealed by sidewalls of the cup.

19. A self-heating element adapted to heat a base portion of a hot beverage reservoir, for receiving a hot beverage for consumption therefrom, to maintain a desired temperature of the hot beverage, during consumption therefrom, without requiring any external power.

20. A reusable hot beverage reservoir, for receiving a hot beverage for consumption therefrom, the hot beverage reservoir defining a heating area at a base thereof, for receiving a self-heating element, the hot beverage reservoir including a substantially planar base, wherein the heating area is defined at least in part by the substantially planar base, such that when the self-heating element is installed into the heating area, heat is transferred to the hot beverage reservoir by the substantially planar base.
